(19) United States
(12) Patent Application Publication
(10) Pub. No.: US 2007/0202359 A1
(43) Pub. Date: Aug. 30, 2007

(54) Magnetic Thin Film For High Frequency, and Method of Manufacturing Same, and Magnetic Device

(75) Inventors: Kyung-Ku Choi, Tokyo (JP); Taku Murase, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 10/573,801

(22) PCT Filed: Sep. 30, 2004
(86) PCT No.: PCT/JP04/14405

§ 371 Date: Jan. 3, 2007

(30) Foreign Application Priority Data
Sep. 30, 2003 (JP) 2003-342470

(51) Int. Cl. B32B 15/00; B32B 19/00; B05D 5/12

(52) U.S. Cl. 428/692.1; 428/693.1; 428/702; 427/131

(57) ABSTRACT

A multilayer film (1) is formed by alternately layering a Co-based amorphous alloy layer (2) and a natural-oxidation layer (3) of the Co-based amorphous alloy (2) on a substrate (4). A magnetic thin film for high frequencies and a magnetic device which can be used in high frequency regions of the GHz band are obtained by making a volume ratio of the natural-oxidation layer (3) to the whole multilayer film (1) fall within a range of 5 to 50%. A magnetic thin film for high frequencies is also obtainable by forming a multilayer film (1) by alternately layering the Co-based amorphous alloy layer (2) having such a characteristic that a direction of magnetic field applied in a film formation process comes to be a direction of an easy magnetization axis of the Co-based amorphous alloy layer and a natural-oxidation layer (3) of the Co-based amorphous alloy, so that the easy magnetization axis of thus formed multilayer film (1) may be perpendicular to the direction of magnetic field applied in the film formation process of the multilayer film (1).

### TECHNICAL FIELD

The present invention relates to a magnetic thin film for high frequencies used in a high frequency region of the GHz band, a method of manufacturing the same, and a magnetic device including the magnetic thin film for high frequencies, and more specifically relates to a magnetic thin film for high frequencies and a method of manufacturing the same, and a magnetic device preferably used in high frequency planar magnetic devices such as a thin film inductor and a thin film transformer and so on and in monolithic microwave integrated circuits (hereinafter referred to as “MMIC”).

### BACKGROUND ART

In accordance with increasing demands for a miniaturization and sophistication of magnetic devices in recent years, magnetic thin film materials exhibiting a high permeability in the GHz band are in demand.

For example, a MMIC, for which demand is growing for use in wireless transmitters/receivers and portable digital assistants, is a high frequency integrated circuit having such a configuration that active elements including a transistor and passive elements including a transmission line, a resistor, a capacitor and an inductor are integrated on a semiconductor substrate made of Si, GaAs, InP or the like. In such a MMIC, the passive elements, in particular, the inductors and capacitors occupy larger areas than the active elements. The occupation of larger areas by the passive elements in the MMIC as a result leads to mass consumption of expensive semiconductor substrates, namely, the cost increase of the MMIC. In order to reduce the producing cost of the MMIC, it is necessary to reduce a chip area, therefore it has been a problem to reduce the areas occupied by the passive elements for that purpose.

Above-mentioned MMIC employs a planar-shaped spiral coil as an inductor. In such a planar spiral coil, in order to obtain the same inductance as usual even with a small occupation area, an increase in the inductance has been achieved by locating a soft magnetic thin film on the upper and lower sides or only on one side thereof (see J. Appl. Phys., and 85, 7919 (1999)). However, for the purpose of applying a magnetic material to inductors for the MMIC, it is firstly demanded that a thin film soft magnetic material, which is high in permeability and low in loss in the GHz band, should be developed. Additionally, high resistivity is also demanded for the purpose of reducing the eddy current loss in high frequencies.

So far, alloys containing as the main component Fe or FeCo have been well known as materials having high saturation magnetization. However, when a magnetic thin film made of an Fe-based alloy or an FeCo-based alloy is prepared by means of film formation techniques such as the sputtering technique, the saturation magnetization of the film obtained is high, but the coercivity thereof is high and the resistivity thereof is low, so that satisfactory high frequency properties thereof can be hardly obtained.

On the other hand, Co-based amorphous alloys are known as materials excellent in soft magnetic properties. Such a Co-based amorphous alloy mainly contains an amorphous substance containing Co as the main component and further one or more elements selected from the group consisting of Y, Ti, Zr, Hf, Nb, Ta and the like. However, although the obtained film has high permeability when a magnetic thin film made of the Co-based amorphous alloys with zero magnetostriction composition is prepared by film formation techniques such as sputtering, saturation magnetization is of the order of 1.1 T (tesla) (=11 kG (kilogauss)), and there is a problem that the saturation magnetization is small compared with that of Fe-based materials. Additionally, for frequencies higher than 100 MHz, a loss component (imaginary part of the permeability, μ2) becomes large, so that the film concerned cannot be judged to be suitable as a magnetic material to be used in high frequencies.

In view of such conventionally-concerned actual conditions, various proposals have been made for the purpose of improving high frequency properties of the soft magnetic thin films. Examples of basic policies to be taken for the improvement include a control of eddy current loss, an increase of resonance frequency, and so on. As specific measures for controlling eddy current loss, for example, multilayer film formation by lamination of a Co-based amorphous alloy layer (0.01-μm to 0.3-μm thick) and an insulating layer (0.02-μm to 0.25-μm thick) is proposed in Japanese Laid-Open Patent Publication No. H7-249516 (the 1st page), in J. Magnetics Soc. Japan, 16, 291 (1992), and in J. Magnetics Soc. Japan, 17, 489 (1993).

As what aimed for realization of GHz inductors using the Co-based amorphous alloy excellent in soft magnetic properties, there have been carried out such attempts that a magnetic thin film is micro-patterned into strips with the longitudinal direction parallel to the easy magnetization axis of the magnetic thin film so that magnetic-shape-anisotropy energy may be increased enough to shift the resonance frequency to high frequency regions (see a J. Magnetics Soc. Japan, 24, 879 (2000) for example).

However, though the magnetic thin films prepared in the above-mentioned processes proposed by Japanese Laid-Open Patent Publication No. H7-249516, J. Magnetics Soc. Japan, 16, 291 (1992) and 17, 489 (1993) may be applicable to the MHz frequency range, they are not so suitable for use in the GHz band.

Besides, the above-mentioned process proposed by J. Magnetics Soc. Japan, 24, 879 (2000) is capable of increasing the intensity of anisotropic magnetic field to the extent of 10⁴/π[A/m] (=40 Oe (oersted)) through micropatterning techniques, so that the resonance frequency can be increased to the GHz band. However, there is a problem that a complicated photolithography process is needed to fabricate such strip-shaped micropatterns.

### DISCLOSURE OF THE INVENTION

The present invention has been designed to overcome the foregoing problems and a first object of the invention is to provide a magnetic thin film for high frequencies to be used in high frequency regions of the GHz band. A second object of the present invention is to provide a method of manufacturing the magnetic thin film for high frequencies having such characteristics. A third object of the present invention is to provide a magnetic device using the magnetic thin film for high frequencies excellent in high frequency properties in the GHz band.

In the process of making a study on a magnetic thin film for high frequencies using Co-based amorphous alloys having soft magnetic properties, inventors of the present invention have found out that an anisotropic magnetic field appears when a multilayered structure is formed with Co-based amorphous alloy layers and oxidation layers of the Co-based amorphous alloys. As a result of further studying the magnetic thin film for high frequencies using the foregoing large anisotropic magnetic field, they have come to know that a large anisotropic magnetic field appears when a volume ratio of the oxidation layers to the whole multilayered structure falls within a predetermined range so that a magnetic thin film excellent in the high frequency properties in the GHz band can be obtained.

A magnetic thin film for high frequencies achieving the above-mentioned first object of the present invention has been provided on the basis of the above-mentioned view, and it is a multilayered structure including a Co-based amorphous alloy layer and an oxidation layer of the Co-based amorphous alloy constituted so that the volume ratio of the oxidation layer to the whole multilayered structure lies within the range of 5 to 50%.

According to the present invention, since a high resistivity and a high anisotropic magnetic field appear in the multilayered structure of the above-mentioned composition, magnetic thin films excellent in high frequency properties in the GHz band are obtainable.

Another magnetic thin film for high frequencies of the present invention is a multilayered structure including: a Co-based amorphous alloy layer having such a characteristic that a direction of a magnetic field applied in a film formation process comes to be a direction of an easy magnetization axis of the Co-based amorphous alloy layer; and an oxidation layer of the Co-based amorphous alloy, wherein the easy magnetization axis of the whole multilayered structure manufactured is perpendicular to the direction of the magnetic field applied in the film formation process.

A Co-based amorphous alloy layer usually has such a characteristic that the direction of a magnetic field applied in the film formation process comes to be a direction of an easy magnetization axis. However, as in the case of the magnetic thin film for high frequencies of the present invention, when a multilayered structure is formed of one or more Co-based amorphous alloy layers and one or more oxidation layers thereof under the magnetic field applied so that the volume ratio of the whole oxidation layer to the whole multilayered structure lies within the range of 5 to 50%, there appears a reversal phenomenon between easy/hard magnetization axes where the easy magnetization axis of the produced multilayered structure is perpendicular to the direction of the magnetic field applied in the film formation process of the multilayered structure. Such phenomenon is considered to be what is called an inverse magnetostrictive effect. Since the magnetic thin film for high frequencies of the present invention exhibits a large anisotropic magnetic field developed on the basis of the foregoing phenomenon as well as an increasing resistivity, a magnetic thin film excellent in the high frequency properties in the GHz band is obtainable.

For the magnetic thin film for high frequencies of the present invention, it is especially preferable that (i) the Co-based amorphous alloy layer is made of a CoZrNb alloy, (ii) a value of resistivity is 150 μΩcm or more, and a value of anisotropic magnetic field is 10⁵/4π[A/m] (=100 Oe) or more, and (iii) a value of ferromagnetic resonance frequency is 2 GHz or more.

A method of manufacturing a magnetic thin film for high frequencies of the present invention for achieving the above-mentioned second object is a way of forming a multilayered structure including a Co-based amorphous alloy layer and an oxidation layer of the Co-based amorphous alloy under a magnetic field applied so that a volume ratio of the oxidation layer to the whole multilayered structure falls within the range of 5 to 50%.

A method of manufacturing another magnetic thin film for high frequencies of the present invention includes: a first step of forming a Co-based amorphous alloy layer under an external magnetic field, the Co-based amorphous alloy layer having such a characteristic that a direction of the external magnetic field applied in a film formation process comes to be a direction of an easy magnetization axis of the Co-based amorphous alloy layer; and a second step of forming an oxidation layer of the Co-based amorphous alloy layer, whereby a multilayered structure including the Co-based amorphous alloy layer and its oxidation layer is formed by alternately repeating the first step and the second step so that the easy magnetization axis of the whole multilayered structure manufactured is perpendicular to the direction of the external magnetic field applied.

When a multilayered structure including one or more Co-based amorphous alloy layers and one or more oxidation layers is formed under the magnetic field applied so that the volume ratio of the oxidation layer to the whole multilayered structure is within the range of 5 to 50%, there appears a reversal phenomenon between the easy/hard magnetization axes where the easy magnetization axis of the multilayered structure is perpendicular to the direction of the magnetic field applied in the film formation process of the multilayered structure. Such a phenomenon is considered to be what is called the inverse magnetostrictive effect. Since the process of producing the magnetic thin film for high frequencies of the present invention can produce a magnetic thin film for high frequencies with high resistivity having a large anisotropic magnetic field developed on the basis of the above-described phenomenon, a magnetic thin film excellent in high frequency properties in the GHz band can be made in a very easy manner.

In the method of manufacturing the high frequency magnetic thin film of the present invention, it is especially preferred that a Co-based amorphous alloy layer be made of a CoZrNb alloy. It is because a zero-magnetostriction composition can be realized easily by use of the CoZrNb alloy, and consequently outstanding soft magnetic properties and high permeability are obtainable.

A magnetic device of the present invention for achieving the above-mentioned third object includes the above-described magnetic thin film for high frequencies, or includes the magnetic thin film for high frequencies formed in the above-described method of manufacturing thereof as a portion.

In the magnetic device of the present invention, it is preferable that: (a) magnetic thin film for high frequencies be arranged opposite to each other to sandwitch a coil; (b) the magnetic device be used in an inductor or a transformer; and (c) the magnetic device be used in a monolithic microwave integrated circuit.

As mentioned above, since the magnetic thin film for high frequencies of the present invention has a high anisotropic magnetic field and a high resistivity, it is possible to provide a magnetic thin film for high frequencies which can be used in high frequency regions of the GHz band. As a result, the magnetic thin film of the present invention can be preferably used as a GHz magnetic thin film applied to an inductor having a planar spiral coil mounted on a MMIC and so on for example. Incidentally, since the magnetic thin film for high frequencies of the present invention is capable of obtaining a good performance even in the condition as formed at room temperature, it is the most suitable for use in such a high frequency integrated circuit as a MMIC for example which is produced in a semi-conductor process that dislikes a heating process.

Moreover, since the method of manufacturing the magnetic thin film for high frequencies of the present invention permits formation of a magnetic thin film for high frequencies having a high resistivity and a large anisotropic magnetic field developed by the phenomenon considered to be the inverse magnetostrictive effect, the magnetic thin film excellent in high frequency properties in the GHz band can be manufactured in a very easy manner.

Since the magnetic device of the present invention is provided with a magnetic thin film for high frequencies having a high anisotropic magnetic field and high resistivity as a portion thereof, a magnetic device with outstanding high frequency properties is obtainable. If the magnetic thin film for high frequencies is applied to a spiral coil in a planar inductor mounted on a MMIC, for example, the inductor can be operated in a good condition as a magnetic device having a value of resonance frequency in the GHz band.

### BRIEF DESCRIPTION OF THE DRAWINGS

FIG. 1 is a schematic view showing an example of a cross sectional structure of a magnetic thin film for high frequencies in an embodiment of the present invention.

FIG. 2 is a graph representing magnetization hysteresis curves of a CoZrNb thin film (comparative example) obtained by carrying out film formation on a substrate upon applying a magnetic field from a certain direction at the time of the film formation.

FIG. 3 is a graph representing resonance frequency characteristics of the CoZrNb thin film shown in FIG. 2.

FIG. 4 is a graph representing magnetization hysteresis curves of a multilayer film (embodiments) made of a CoZrNb thin film and a natural-oxidation layer, which were obtained by film formation process on a substrate upon applying a magnetic field from a certain direction at the time of the film formation.

FIG. 5 is a graph representing resonance frequency characteristics of the multilayer film shown in FIG. 4.

FIG. 6A is a plan view showing a configuration of an inductor in the case of applying a planar magnetic device for use in the inductor.

FIG. 6B is an example of a sectional view showing the configuration of the inductor indicated in FIG. 6A.

FIG. 7 is a schematic cross sectional view showing another example in the case of applying a planar magnetic device of the embodiment of the present invention to an inductor.

FIG. 8 is a schematic plan view of a conductor layer portion extracted from an inductor.

FIG. 9 is a schematic cross-sectional view along the A-A line in FIG. 8.

FIG. 10 shows a confirmation experimental result of a magnetization shift phenomenon.

### BEST MODE FOR CARRYING OUT THE INVENTION

Hereinafter, a magnetic thin film for high frequencies of the present invention, a method of manufacturing the same, and a magnetic device will be described by referring to the drawings. It is to be noted that the range of the present invention is not limited to embodiments described below.

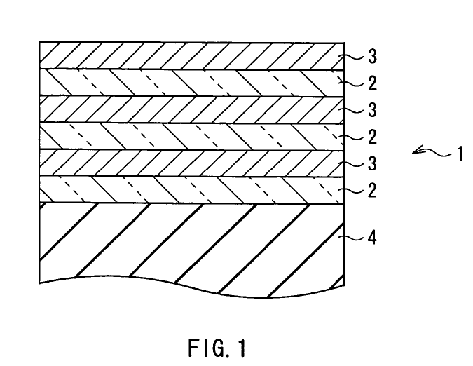

FIG. 1 is a schematic cross-sectional view showing an example of a cross-sectional form of a magnetic thin film for high frequencies of the present invention.

A magnetic thin film for high frequencies 1 of the present invention is, as shown in FIG. 1, a multilayer film formed by alternately layering a Co-based amorphous alloy layer 2 and a natural-oxidation layer 3 of the Co-based amorphous alloy on a substrate 4. The volume ratio of the natural-oxidation layer 3 to the whole multilayer film is 5 to 50%.

(Co-Based Amorphous Alloy Layer)

The Co-based amorphous alloy layer 2 is an amorphous alloy containing Co, and has such a characteristic that a direction of a magnetic field applied in a film formation process serves as the easy magnetization axis thereof. A Co-based amorphous alloy having a high permeability and a high resistivity (a value of the resistivity is 100-120 μΩcm) is effective in controlling eddy current loss in high frequencies, and therefore is preferably applied to the present invention. The Co-based amorphous alloy layer preferably has such properties that, as a single layer film, a value of permeability is 1,000 (at 10 MHz) or more, a value of saturation magnetization is 1.0 T (=10 kG) or more, and a value of resistivity is 100 μΩcm or more.

This Co-based amorphous alloy, which mainly contains Co and further includes one or more kinds of additive elements selected from the group consisting of B, C, Si, Ti, V, Cr, Mn, Fe, Ni, Y, Zr, Nb, Mo, Hf, Ta and W, is constituted mainly with an amorphous phase. Incidentally, an amorphous alloy, or an amorphous phase generally represents those where a diffraction pattern obtained in an X-ray diffraction measurement exhibits no remarkable crystalline peaks, that is, showing what is called a broad diffraction peak.

The proportion of the additive element (or the total proportion in case of a plurality of additive elements) added to the Co-based amorphous alloy is usually 5 to 50 at %, preferably 10 to 30 at %. If the proportion of the additive elements exceeds 50 at %, there occurs such an inconvenience that a value of saturation magnetization will become small. On the other hand, if the proportion of the additive elements is less than 5 at %, it becomes difficult to control magnetostriction, and there occurs such an inconvenience that effective soft magnetic properties are no longer obtained.

Examples of the Co-based amorphous alloy include CoZr, CoHf, CoNb, CoMo, CoZrNb, CoZrTa, CoFeZr, CoFeNb, CoTiNb, CoZrMo, CoFeB, CoZrNbMo, CoZrMoNi, CoFeZrB, CoFeSiB, CoZrCrMo, and the like. Among them, CoZrNb is especially preferred because of its advantageous characteristics that a zero-magnetostriction composition (for example, Co₈₇Zr₅Nb₈) can be realized easily in CoZrNb so that a magnetic thin film for high frequencies excellent in soft magnetic properties with high permeability may be obtainable as a result.

(Natural-Oxidation Layer)

The natural-oxidation layer 3 is an oxidation layer automatically generated when the surface of the above-mentioned Co-based amorphous alloy layer 2 contacts oxygen, including for example an oxidation layer formed in the atmosphere, a purified water, or in a chemical as well as such an oxidation layer as formed in residual oxygen and residual water in a film formation system.

The natural-oxidation layer 3 to be formed is usually of the order of 0.1-2.0 nm in thickness, and is not formed so thick because it is a naturally-oxidized layer. Further, the resistivity is of the order of 10³-10⁶ μΩcm.

(Multilayer Film)

The multilayer film 1 of the present invention is formed by alternately layering the Co-based amorphous alloy layer 2 and the natural-oxidation layer 3. More specifically, it is formed by alternately performing: a step of forming the Co-based amorphous alloy layer 2 on the substrate upon applying a magnetic field from a certain direction at the time of film formation; and a step of forming the natural-oxidation layer 3 on the surface of the Co-based amorphous alloy layer.

It is preferable that the multilayer film 1 of the present invention be formed by a vacuum thin film formation technique, in particular, the sputtering technique. More specifically, there are used the RF sputtering, DC sputtering, magnetron sputtering, ion beam sputtering, inductively coupled RF plasma assisted sputtering, ECR sputtering, facing target sputtering, and the like. Incidentally, the sputtering is merely one possible mode of the present invention, and hence, needless to say, other thin film formation techniques can be applied.

As a target for depositing the Co-based amorphous alloy layers, a composite target may be used in which a pellet of a desired additive element is arranged on a Co target, and a Co-alloy target containing a desired additional component may be used.

Incidentally, examples of the substrate 4 (reference to FIG. 1) on which the multilayer film 1 of the present invention is formed include a glass substrate, a ceramic material substrate, a semiconductor substrate, a resin substrate and the like. Examples of ceramic materials include alumina, zirconia, silicon carbide, silicon nitride, aluminum nitride, steatite, mullite, cordierite, forsterite, spinel, ferrite and the like. It is preferable that, among these materials, aluminum nitride should be used which is high both in thermal conductivity and in flexural strength.

Besides, since the multilayer film of the present embodiment can exhibit its performance in the condition as formed at room temperature (about 15-35 degrees C.), it is a material most suitable for high frequency integrated circuits produced in such semiconductor processes as of MMICs. Therefore, examples of the substrate 4 include semiconductor substrates such as Si, GaAs, InP, and SiGe and the like.

The multilayer film 1 is formed by repeating such a process as described above, wherein neither the number of layers nor the thickness of the whole multilayer film is particularly restricted. The resistivity of the multilayer film 1 composed of the Co-based amorphous alloy layer 2 and its natural-oxidation layer 3 is 150 μΩcm or more, and the anisotropic magnetic field Hk of the multilayer film 1 is 10⁵/4π[A/m] (=100 Oe) or more. The reason the resistivity is 150 μΩcm or more is that the Co-based amorphous alloy layer 2 in itself has the resistivity of 100 μΩcm or more, and also the natural-oxidation layer 3 has the resistivity of 103 μΩcm or more. The reason the anisotropic magnetic field is 10⁵/4π[A/m] or more is considered to be based on a magnetization shift phenomenon as described below.

That is, in the multilayer film 1 of the present invention, when the volume ratio of the natural-oxidation layer 3 to the whole multilayer film is 5 to 50%, there appears the magnetization shift phenomenon where the easy magnetization axis of the prepared multilayer film 1 is perpendicular to the direction of the magnetic field applied in the film formation process of the multilayer film (shifted by 90 degrees). Such a phenomenon is considered to be what is called an inverse magnetostrictive effect. The volume ratio of the natural-oxidation layer 3 to the whole multilayer film is preferably within the range of 10% to 45%.

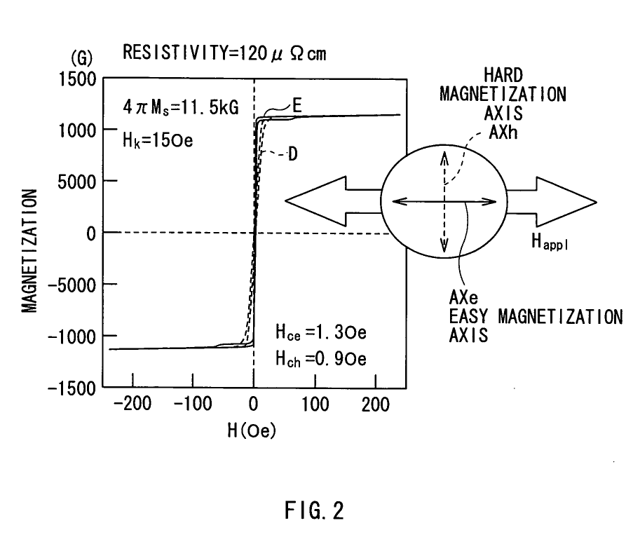

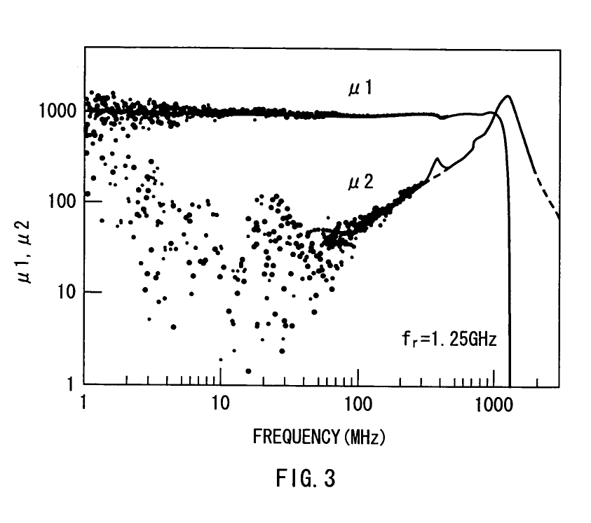

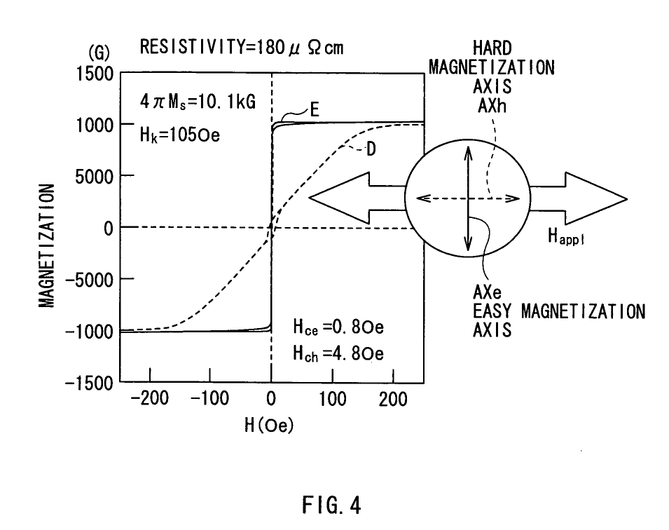

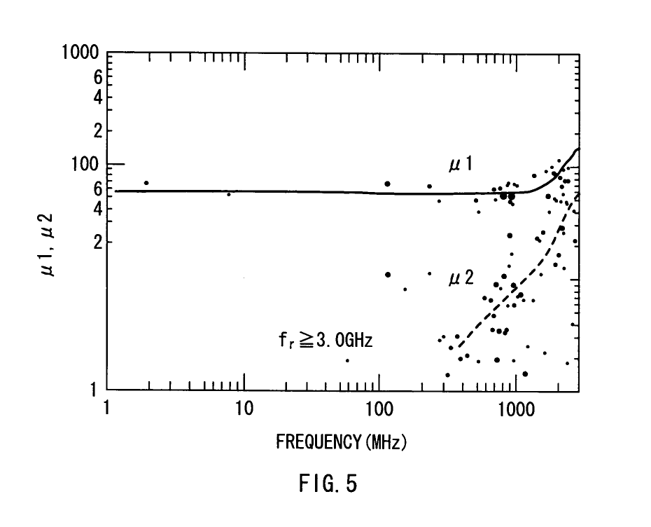

FIG. 2 shows a graph representing magnetization hysteresis curves of a CoZrNb thin film (comparative example) with a thickness of 500 nm obtained through a film formation on the substrate upon applying a magnetic field from a certain direction at the time of film formation, and FIG. 3 is a graph representing resonance frequency characteristics of the obtained CoZrNb thin film. FIG. 4 is a graph representing magnetization hysteresis curves of a multilayer film (examples) with a thickness of 450 nm, which is obtained by alternately layering a 8-nm-thick CoZrNb thin film and a 1-nm-thick natural-oxidation layer on a substrate, the film formation process being carried out upon applying a magnetic field from a certain direction at the time of the film formation, and FIG. 5 is a graph representing resonance frequency characteristics of the obtained multilayer film. In the multilayer film used for FIGS. 4 and 5, the volume ratio of the natural-oxidation layer to the whole multilayer film is 11%. Incidentally, in FIGS. 2 and 4, the axis of abscissa represents external applied magnetic field H (unit: Oe), and an axis of ordinate represents magnetization (unit: G). The reference mark “E” represents a magnetization curve in the direction of the easy magnetization axis, and the reference mark “D” represents a magnetization curve in the direction of the hard magnetization axis. In FIGS. 3 and 5, furthermore, the axis of abscissa represents frequency (unit: MHz), and the axis of ordinate represents a real part μ1 of permeability and an imaginary part μ2.

As shown in FIG. 2, in the CoZrNb thin film, it is common that the direction of magnetic field Happ1 applied in a film formation process is in agreement with the direction of the easy magnetization axis “AXe”, therefore the direction of hard magnetization axis “AXh” is perpendicular to the direction of the magnetic field Happ1 applied in the film formation process. However, although the CoZrNb thin film has resistivity comparatively as high as 120 μΩcm, since anisotropic magnetic field Hk thereof is as small as 15×10³/4π[A/m] (=15 Oe), the resonance frequency characteristics will fall in the place over fr=1 GHz as shown in FIG. 3.

On the other hand, as shown in FIG. 4, in the multilayer film made of CoZrNb thin films and natural-oxidation layers, the direction of the magnetic field Happ1 applied in the film formation process and the direction of the easy magnetization axis “Axe” are not in agreement but perpendicular to each other. In other words, the direction of the magnetic field Happ1 applied in the film formation process and the direction of the hard magnetization axis “Axh” are in agreement. At this time, the obtained multilayer film has resistivity of as high as 180 μΩcm, and moreover, a value of anisotropic magnetic field Hk is also as high as 105×10³/4π[A/m] (=105 Oe). The stronger the anisotropic magnetic field Hk is, the more excellent high frequency properties are obtainable for the multilayer film. Therefore, as shown in FIG. 5 in practice, there is an effect of avoiding the depression of the resonance frequency characteristics even over fr=2 GHz.

If the volume ratio of the natural-oxidation layer 3 to the whole multilayer film of the present invention is less than 5%, such a magnetization shift phenomenon may not appear. On the other hand, since the ratio of a nonmagnetic component becomes larger than that of a magnetic component when the ratio of the natural-oxidation layer 3 exceeds 50% of the whole, the activity as a soft magnetic material is difficult.

(High Frequency Properties of Multilayer Film)

Since the multilayer film of the present invention has the configuration mentioned above, it has such outstanding high frequency properties that the resistivity is 150 μΩcm or more, the anisotropic magnetic field is 10⁵/4π[A/m] (=100 Oe) or more, and the ferromagnetic resonance frequency is 2 GHz or more. Such characteristics can be obtained in the condition as formed without performing a heat treatment, etc.

(Magnetic Device)

A magnetic device of the present invention includes the above-described magnetic thin film for high frequencies as a portion thereof.

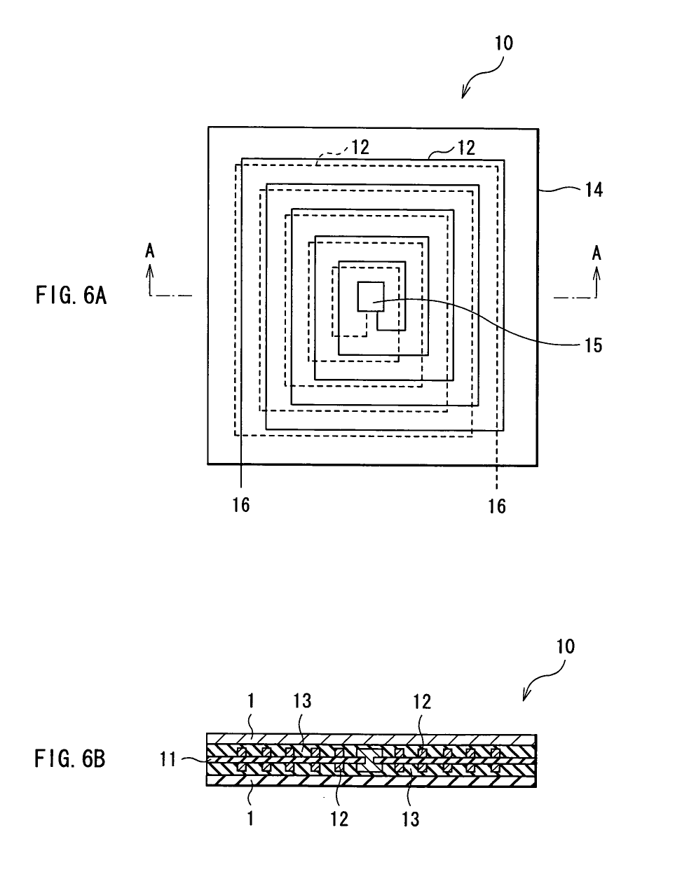

FIG. 6A schematically shows a plan view of an inductor employing a planar magnetic device, and FIG. 6B schematically shows a cross-sectional structure along the A-A line of FIG. 6A.

An inductor 10 includes a substrate 11, planar coils 12 formed in a spiral shape on the both sides of the substrate 11, insulating films 13 formed so as to cover the planar coils 12 and the substrate 11, and a pair of magnetic thin film for high frequencies 1 of the present invention formed so as to cover the respective insulating films 13. The magnetic thin film for high frequencies 1 has the same configuration as what is appearing in FIG. 1. Additionally, the two planar coils 12 are electrically connected to each other through a throughhole 15 formed in an approximately central location on the substrate 11. Furthermore, from the planar coils 12 on the both sides of the substrate 11, terminals 16 are extended for connection so as to be accessible from the outside. The inductor 10 is configured in such a way that a pair of the magnetic thin film for high frequencies 1 sandwich the planar coils 12 with the insulating films 13 in between, so that an inductor may be formed between the connection terminals 16.

The inductor formed in this way is small and thin in shape and light in weight, and exhibits excellent inductance particularly in the high frequency band of 1 GHz or above. Additionally, in the above described inductor 10, a transformer can be formed by arranging a plurality set of the planar coils 12 in a parallel manner.

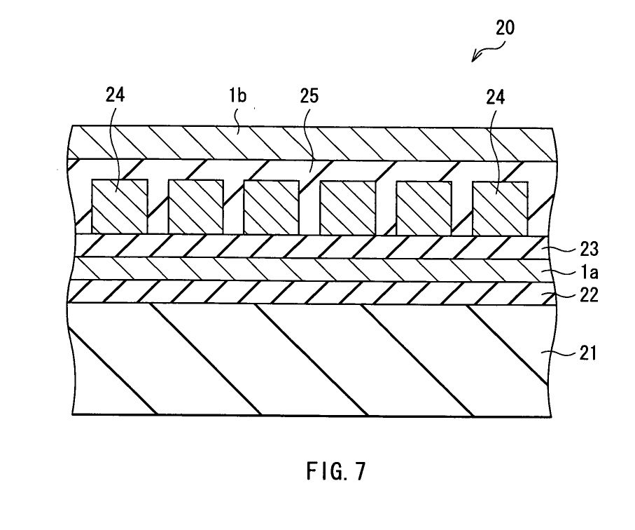

FIG. 7 is a schematic cross sectional view showing another example in which a planar magnetic device of the present embodiment was applied to an inductor.

As shown in this figure, an inductor 20 includes a substrate 21, an oxide film 22 formed on the substrate 21 as needed, a magnetic thin film for high frequencies 1a formed on the oxide film 22, and an insulating film 23 formed on the magnetic thin film for high frequencies 1a, and furthermore, has planar coils 24 formed on the insulating film 23, an insulating film 25 formed so as to cover the planar coils 24 and the insulating film 23, and a magnetic thin film for high frequencies 1b of the present invention formed on the insulating film 25. The magnetic thin film for high frequencies 1a and 1b have the same configuration as that of the above-mentioned magnetic thin film for high frequencies 1 (FIG. 1). The inductor 20 formed in this way is also small and thin in shape and light in weight, and exhibits excellent inductance particularly in the high frequency band of 1 GHz or above. Additionally, in the inductor 20 as described above, a transformer can be formed by arranging a plurality of the planar coils 24 in a parallel manner.

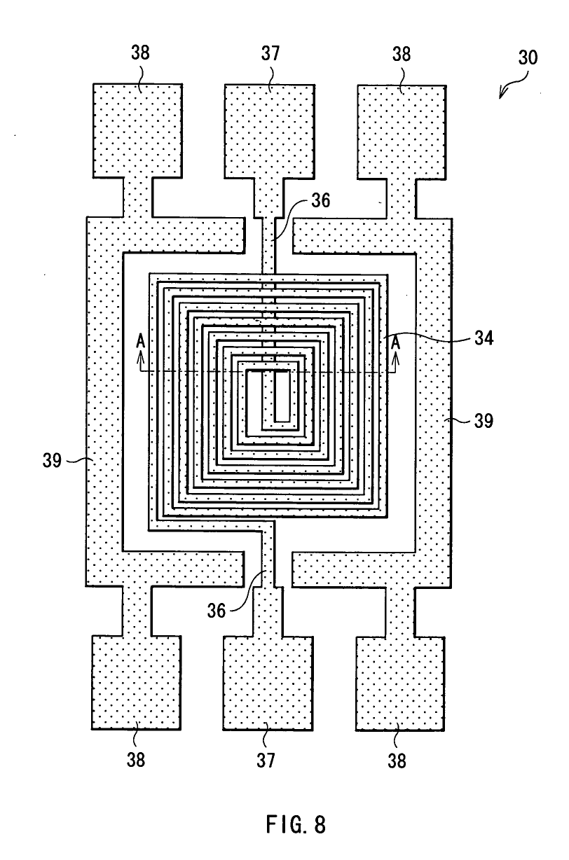

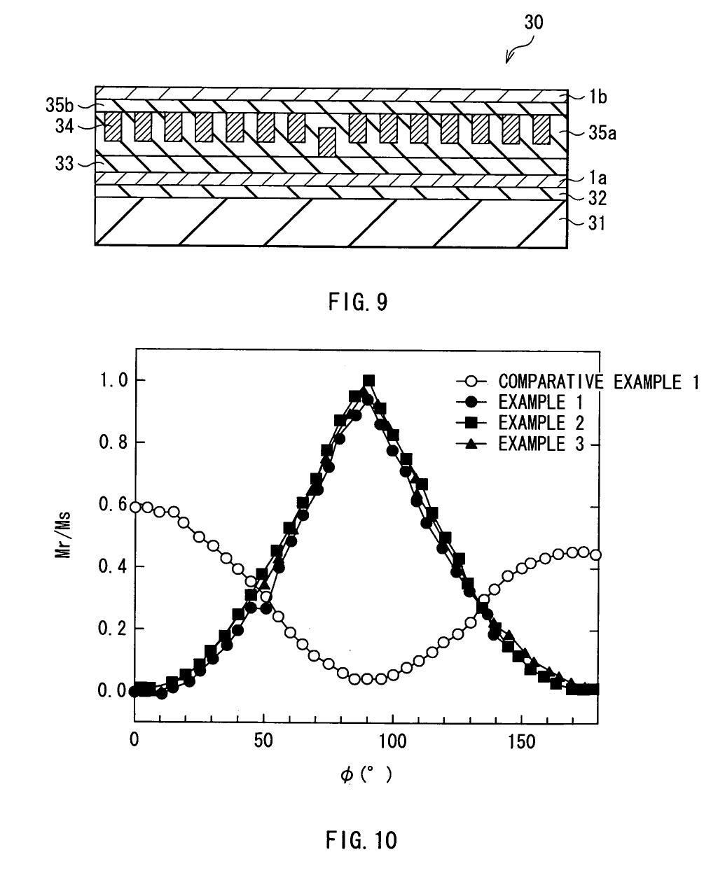

FIGS. 8 and 9 show an example in which the magnetic thin film for high frequencies 1 was applied to an inductor for use in a MMIC; FIG. 8 schematically shows a plan view of a conductor layer portion extracted from the inductor, and FIG. 9 schematically shows a cross sectional view along the line A-A in FIG. 8.

An inductor 30 illustrated by these figures includes a substrate 31, an insulating oxide film 32 formed on the substrate 31 as needed, a magnetic thin film for high frequencies 1a of the present invention formed on the insulating oxide film 32, and an insulating film 33 formed on the magnetic thin film for high frequencies 1a, and furthermore, has a spiral coil 34 formed on the insulating film 33, insulating films 35a, 35b formed so as to cover the spiral coil 34 and the insulating film 33, and a magnetic thin film for high frequencies 1b of the present invention formed on the insulating film 35b. The magnetic thin film for high frequencies 1a and 1b have the same configuration as the above-mentioned magnetic thin film for high frequencies 1 (FIG. 1).

Besides, the spiral coil 34 is connected to a pair of electrodes 37 through a wiring 36. A pair of ground patterns 39 arranged so as to surround the spiral coil 34 are respectively connected to a pair of ground electrodes 38, thus forming a shape for evaluating the frequency properties on a wafer by means of a ground-signal-ground (G-S-G) probe.

The inductor for use in a MMIC having the shape of the present embodiment adopts a cored structure in which the spiral coil 34 is sandwiched by the magnetic thin film for high frequencies 1a, 1b to form a magnetic core. Consequently, the inductance value is improved by about 50% when compared with an inductor adopting an air core structure in which the spiral coil 34 has the same shape but the magnetic thin film for high frequencies 1a, 1b are not formed thereon. Thus, the occupation area of the spiral coil 34 needed for attaining the same inductance value can be made smaller, and consequently the miniaturization of the spiral coil 34 can be realized.

By the way, materials for the magnetic thin film applied to the inductors for use in a MMIC are required to have a high permeability and high quality factor Q (low loss) properties in high frequencies of the GHz band, and to permit the integration in semiconductor manufacturing processes.

For the purpose of realizing high permeability for high frequencies in the GHz band, materials high both in resonance frequency and saturation magnetization are advantageous, and the control of the uniaxial magnetic anisotropy is necessary. Additionally, for the purpose of attaining a high quality factor Q, the suppression of the eddy current loss caused by high resistance is important. Furthermore, for the purpose of application to the integration process, it is desirable that film formation can be performed at room temperature and the films thus formed can be used in the condition as formed so that the performances and the fabrication processes of other on-chip components that have already undergone setting can be free from the possible adverse effects caused by heating.

### EXAMPLES

Hereinafter, the magnetic thin film for high frequencies of the present embodiment will be explained in more detail based on examples and a comparative example.

### Example 1

A magnetic thin film for high frequencies described in Example 1 was produced according to the following film formation techniques.

First, a Si wafer on which a 500-nm thick SiO₂ film was formed was used as a substrate. Next, a magnetic thin film for high frequencies was deposited on the substrate by use of a facing target sputtering apparatus according to the following ways. That is, preliminary evacuation of the interior of the facing target sputtering apparatus was carried out to 8×10⁻⁵ Pa, thereafter Ar gas was introduced into the apparatus until the pressure thereof reached 10 Pa, and then the substrate surface was subjected to sputter etching at an RF power of 100 W for 10 minutes. Subsequently, the Ar gas flow was adjusted so that the pressure might be set to 0.4 Pa, then sputtering of a Co₈₇Zr₅Nb₈ target was carried out by the power of 300 W and consequently an amorphous film with Co₈₇Zr₅Nb₈ composition was produced.

Subsequently, a natural-oxidation layer was formed. The natural-oxidation layer was prepared by, after forming each metal layer, introducing O₂ gas with 2 sccm into the interior of the sputtering apparatus for 30 seconds and oxidizing the surface of the each metal layer. After forming the natural-oxidation layer, the sputtering apparatus was evacuated down to the 10 s⁻⁴-Pa range.

At the time of deposition, a DC bias of 0 V to −80 V was applied to the substrate. For the purpose of preventing effects of impurities on the surfaces of the targets, target-presputtering was conducted for 10 minutes or more with a shutter closed. Thereafter, with the shutter opened, the deposition onto the substrate was carried out. The deposition rate in forming the CoZrNb layer was set to 0.33 nm/sec. The film thickness of the Co-based amorphous alloy layer was adjusted by controlling the opening and closing time of the shutter.

In the film formation process, at first, a 8.0-nm-thick CoZrNb layer as the 1st layer on the substrate was formed upon applying a magnetic field intensity of about 35×10³/4π[A/m] (=35 Oe) and then a 1.0-nm-thick natural-oxidation layer was formed as the 2nd layer thereon, and again forming another CoZrNb layer on the foregoing natural-oxidation layer as a new cycle. Such a film formation cycle was repeated 50 times, and consequently a magnetic thin film (example 1) with the characteristics shown in Table 1 was obtained (the total thickness: 450 nm). In this case, the volume ratio of the natural-oxidation layer to the whole multilayer film was 11%.

FIG. 4 mentioned above shows the hysteresis curves of the magnetic thin film obtained in Example 1, and FIG. 5 shows the high frequency properties of the magnetic thin film. As is clear from the exhibited magnetization curves, in the deposited film, there was confirmed a phenomenon that the direction of applied magnetic field was shifted 90 degrees relative to (intersected perpendicularly with) the easy magnetization direction. At this time, a value of saturation magnetization 4 πMs was 1.01 T (=10.1 kG), a value of coercitivity Hce in the easy magnetization direction was 63.7 A/m (=0.8 Oe), and a value of coercitivity Hch in the hard magnetization direction was 382 A/m (=4.8 Oe). Besides, a value of anisotropic magnetic field Hk was 8360 A/m (=105 Oe). As is clear from the graph of high frequency permeability properties shown in FIG. 5, resonance frequency was over 3 GHz, exceeding the limit of measurement, and a value of 80 was acquired at 1.0 GHz as a value of the real part (μ1) of permeability. A value of resistivity was 180 μΩcm. Incidentally, the high frequency permeability measurement was made by use of an ultra high frequency permeability measurement apparatus (Ryowa Electronics Co., Ltd., PMF-3000), and the magnetic properties were measured by use of a vibrating sample magnetometer (Riken Denshi Co., Ltd., BHV-35).

### Example 2

On the basis of the above described film formation technique of Example 1, a 2.3-nm thick CoZrNb layer and a 1.0-nm thick natural oxidation layer were alternately layered each in 121 times in a successive manner, and consequently a magnetic thin film (Example 2) having a total film thickness of 400 nm (242 layers in total) was formed. At this time, the volume ratio of the natural-oxidation layer to the whole multilayer film was 30%.

The magnetic properties of the obtained magnetic thin film are represented in Table 1. A value of saturation magnetization 4 πMs was 0.80 T (=8.0 kG), a value of coercitivity Hce in the easy magnetization direction was 1400 A/m (=17.6 Oe) and a value of coercitivity Hch in the hard magnetization direction was 2950 A/m (=37 Oe). A value of high frequency permeability property obtained was 40 at 1.0 GHz, as a value of the permeability real part (μ1), and a value of resistivity was 860 μΩcm.

### Example 3

Based on the film formation technique of the above-mentioned Example 1, after forming a CoZrNb layer of 1.6 nm in thickness, a 1.3 nm natural-oxidation layer was formed by introducing O₂ gas with 5 sccm into the interior of the sputtering apparatus for 30 seconds to oxidize the surface of metal layers. The CoZrNb layer of 1.6 nm in thickness and the natural-oxidation layer of 1.3 nm in thickness were alternately formed 138 times respectively in a successive manner, and consequently a magnetic thin film (Example 3) having a total film thickness of 400 nm (276 layers in total) was formed. At this time, the volume ratio of the natural-oxidation layer to that of the whole multilayer film was 45%.

The magnetic properties of the obtained magnetic thin film are shown in Table 1. A value of saturation magnetization was 0.63 T (=6.3 kG), a value of coercitivity Hce in the easy magnetization direction was 1750 A/m (=22 Oe), and a value of coercitivity Hch in the hard magnetization direction was 3260 A/m (=41 Oe). A value of high frequency permeability property obtained was 25 at 1.0 GHz, as a value of the permeability real part (μ1), and a value of resistivity was 1416 μΩcm.

### Comparative Example 1

Based on the film formation technique of the above-mentioned Example 1, a monolayer of CoZrNb film of 500 μm in thickness was formed to be a magnetic thin film for Comparative example 1.

Physical property values of the magnetic thin film concerned were measured and acquired on the basis of the processes in conformity with the above described examples: as shown in Table 1, a value of saturation magnetization was 1.15 T(=11.5 kG); a value of coercivity Hce in the easy magnetization axis direction was 104 A/m (=1.3 Oe); and a value of coercivity Hch in the hard magnetization axis direction was 71.6 A/m (=0.9 Oe). A value of high frequency permeability property obtained was 1000 at 1.0 GHz, as a value of the permeability real part (μ1), and a value of resistivity was 120 μΩcm.

Result

Table 1 collects the results acquired by the above described examples and comparative example. As shown in Table 1, according to the respective examples 1-3 in the present embodiment, the high resonant frequency property and the high resistance property can be obtained. Incidentally, since only the real parts μ1 for the permeability at 1 GHz are shown in Table 1, and the values of the μ1 for Examples 1-3 are smaller than the μ1 value for Comparative example 1, it is seen as if the properties for the Examples were inferior to the properties for the Comparative example. Actually, however, since the value of the permeability imaginary part 112 at 1 GHz for the Examples is small enough (<2) compared with the imaginary part μ2 (≈1000) for the Comparative example as shown in FIGS. 3 and 5, in view of the quality factor Q (=μ1/μ2), the Q values for the Examples are found out to be large enough compared with the Q value for the Comparative example. The imaginary part μ2 is indicative of loss, therefore the smaller it is, the larger the Q value will come to. If the Q value is large, that means the loss is small. In short, the loss at 1 GHz is reduced in the Examples compared with the loss in the Comparative example, proving that the characteristics have been remarkably improved.

FIG. 10 shows a confirmation experimental result of the magnetization reversal phenomenon. In the confirmation experiment, residual magnetization (Mr) was measured upon rotating samples in in-plane directions (angular deviations from the direction of applied magnetic field in the film formation process are indicated in the abscissa axis as “1”) by use of the vibrating sample magnetometer (Riken Denshi Co., Ltd., BHV-35) apparatus, then the measured values were normalized with saturation magnetization values (Ms) and indicated on the coordinate axis. As a result of contrasting the magnetic thin films for Examples 1-3 with the magnetic thin film for the comparative example 1, as represented, there was a difference of 90 degrees between the easy magnetization axes. Accordingly, it has proved that, in the Examples 1-3, the direction of magnetic field applied in the film formation process is perpendicular to the direction of the easy magnetization axis of the obtained magnetic thin film (refer to FIG. 4), while in the Comparative example 1, the direction of magnetic field applied in the film formation process is in parallel with the direction of the easy magnetization axis of the obtained magnetic thin film (refer to FIG. 2).

[Table 1]

(see the appendix “Table 1”)

As mentioned above, some embodiments and examples were given to describe the present invention, but it is to be noted that the present invention is not limited to the above-described embodiments or examples, and can be modified in various ways. For example, Co-based amorphous alloy is not limited to the materials or compositions described in the above-mentioned embodiments and examples. Oxidation layers of Co-based amorphous alloy in the present invention are not limited to the natural-oxidation layer 3 but, for example, may be an oxide film prepared by compulsory oxidation treatment, such as heat oxidation. Moreover, application of the magnetic thin film for high frequencies is not limited to such devices as MMICs and high frequency planar magnetic devices including a thin film inductor and a thin film transformer, but can be applied to other devices.

TABLE 1

| | | CoZrNb | Natural-oxidation | Saturation | | | | | | |
|---|---|---|---|---|---|---|---|---|---|---|
| | Natural-oxidation | thickness | layer thickness | magnetization | Hce | | Hk | fr | Resistivity | μ1 |
| | layer (vol %) | (nm) | (nm) | (kG) | (Oe) | Hch | (Oe) | (GHz) | (μΩcm) | at 1 GHz |
| Example 1 | 11 | 8 | 1 | 10.1 | 0.8 | 4.8 | 105 | ˜3 | 180 | 80 |
| Example 2 | 30 | 2.3 | 1 | 8 | 17.6 | 37 | 200 | 2.5 | 860 | 40 |
| Example 3 | 45 | 1.6 | 1.3 | 6.3 | 22 | 41 | >250 | >3 | 1416 | 25 |
| Comparative | 0 | 500 | 0 | 11.5 | 1.3 | 0.9 | 15 | 1.25 | 120 | 1000 |
| Example 1 | | | | | | | | | | |

1. A magnetic thin film for high frequencies with a multilayered structure, the multilayered structure comprising:
a cobalt (Co)-based amorphous alloy layer; and
an oxidation layer of the Co-based amorphous alloy,
wherein a volume ratio of the oxidation layer to the whole multilayered structure lies within the range of 5% to 50%.

2. A magnetic thin film for high frequencies with a multilayered structure,
the multilayered structure comprising:
a Co-based amorphous alloy layer having such a characteristic that a direction of a magnetic field applied in a film formation process comes to be a direction of an easy magnetization axis of the Co-based amorphous alloy layer; and
an oxidation layer of the Co-based amorphous alloy,
wherein the easy magnetization axis of the whole multilayered structure manufactured is perpendicular to the direction of the magnetic field applied in the film formation process.

3. The magnetic thin film according to claim 1, wherein the Co-based amorphous alloy layer is made of a cobalt-zirconium-niobium (CoZrNb) alloy.

4. The magnetic thin film according to claim 2, wherein the Co-based amorphous alloy layer is made of a cobalt-zirconium-niobium (CoZrNb) alloy.

5. The magnetic thin film according to claim 1, wherein a value of resistivity is 150 μΩcm or more, and a value of anisotropic magnetic field intensity is 10⁵/4π[A/m] or more.

6. The magnetic thin film according to claim 2, wherein a value of resistivity is 150 μΩcm or more, and a value of anisotropic magnetic field intensity is 10⁵/4π[A/m] or more.

7. The magnetic thin film according to claim 1, wherein a value of ferromagnetic resonance frequency is 2 GHz or more.

8. The magnetic thin film according to claim 2, wherein a value of ferromagnetic resonance frequency is 2 GHz or more.

9. A method of manufacturing a magnetic thin film for high frequencies,
the method comprising a step of forming a multilayered structure under a magnetic field applied, the multilayered structure including a Co-based amorphous alloy layer and an oxidation layer of the Co-based amorphous alloy, so that a volume ratio of the oxidation layer to the whole multilayered structure falls within a range of 5% to 50%.

10. A method of manufacturing a magnetic thin film for high frequencies comprising a step of alternately repeating a first step and a second step thereby forming a multilayered structure including the Co-based amorphous alloy layer and the oxidation layer thereof, wherein;
in the first step a Co-based amorphous alloy layer is formed under an external magnetic field, the Co-based amorphous alloy layer having such a characteristic that a direction of the external magnetic field applied in a film formation process comes to be a direction of an easy magnetization axis of the Co-based amorphous alloy layer, and
in the second step an oxidation layer of the Co-based amorphous alloy is formed,
whereby the easy magnetization axis of the whole multilayered structure manufactured is perpendicular to the direction of the external magnetic field applied.

11. The method of manufacturing a magnetic thin film according to claim 9, wherein the Co-based amorphous alloy layer is made of a CoZrNb alloy.

12. The method of manufacturing a magnetic thin film according to claim 10, wherein the Co-based amorphous alloy layer is made of a CoZrNb alloy.

13. A magnetic device comprising, as a portion thereof, the magnetic thin film for high frequencies described in claim 1.

14. A magnetic device comprising, as a portion thereof, the magnetic thin film for high frequencies described in claim 2.

15. The magnetic device according to claim 13 further comprising a coil, wherein a pair of the magnetic thin films for high frequencies are provided opposite to each other to sandwich the coil.

16. The magnetic device according to claim 14 further comprising a coil, wherein a pair of the magnetic thin films for high frequencies are provided opposite to each other to sandwich the coil.

17. The magnetic device according to claim 13, wherein the magnetic device is used for an inductor or a transformer.

18. The magnetic device according to claim 14, wherein the magnetic device is used for an inductor or a transformer.

19. The magnetic device according to claim 13, wherein the magnetic device is used for a monolithic microwave integrated circuit.

20. The magnetic device according to claim 14, wherein the magnetic device is used for a monolithic microwave integrated circuit.
